(19) United States
(12) Patent Application Publication
(10) Pub. No.: US 2024/0249260 A1
(43) Pub. Date: Jul. 25, 2024

(54) DIGITAL FINANCIAL MANAGEMENT OVER A COMMUNICATION NETWORK

(71) Applicant: Truist Bank, Charlotte, NC (US)

(72) Inventors: Melissa Waldberg, Charlotte, NC (US); Bastien Buchaca, Charlotte, NC (US); Brooke Ferry, Charlotte, NC (US); Rahul Gupta, Charlotte, NC (US); Trambak Adhya, Charlotte, NC (US); Saswata Panda, Charlotte, NC (US); David Hitt, Charlotte, NC (US)

(21) Appl. No.: 18/158,941

(22) Filed: Jan. 24, 2023

(51) Int. Cl. G06Q 20/10; G06Q 20/32

(52) U.S. Cl. CPC G06Q 20/108; G06Q 20/3224

(57) ABSTRACT

An apparatus, computing device, computer program product, and a computer-implemented method for delivering financial services and, more particularly, for facilitating enhanced network communication between a user and a financial institution. The computing device is operable to dynamically conduct a geographic location analysis of data relating to a current geographic location of a client device executing a mobile application or a desktop application associated with a financial institution over a communication network. The computing device is operable to cause, based on the geographic location analysis, display of a dashboard on the client device and a widget on the dashboard that includes a profile of a branch employee of the financial institution.

### TECHNICAL FIELD

The present disclosure relates to an apparatus, computing device, computer program product, and computer-implemented method for delivering financial services and, more particularly, for facilitating enhanced network communication between a user and a financial institution.

### BACKGROUND

Financial institutions that provide financial services are increasingly providing a greater number of client services. Traditional services extended by financial institutions to customers required in-person visits by customers. Accordingly, financial institutions focused on in-person customer interaction to enhance the quality of services. This simplified model of financial services, while still in use, has been greatly expanded.

Financial institutions now offer digital or online financial services customers, thereby obviating the need for in-person visits to the financial institution. In this way, customers can receive financial services at home via a computing device in order to access and manage one or more user accounts, such as online bill payments, money transfers, etc.

While user receipt of digital or online financial services is convenient, financial institutions would like to maintain the same level of quality of service received by customers during in-person visits.

### SUMMARY

One or more embodiments of the present disclosure relate to a communication environment that facilitates enhanced user communication with a financial institution in support of user access and user management of user accounts at the financial institution. Upon the launching of a dashboard of financial institution on a client device, a user may receive data and information on one or more branch employees based on the geographic location of the user, or a user request or query for one or more financial services that are offered by the financial institution.

In accordance with one or more embodiments set forth, illustrated, and described herein, an apparatus comprises one or more of the following: one or more processors; and a non-transitory memory coupled to the one or more processors, the non-transitory memory including a set of instructions, which when executed by the one or more processors, cause the apparatus to: dynamically conduct a geographic location analysis of wireless network connectivity data, stored geographic location data, and sensor data relating to a current geographic location of a client device executing a mobile application or a desktop application associated with a financial institution over a communication network; and cause, based on the geographic location analysis, display of a dashboard on the client device and a widget on the dashboard.

In accordance with the apparatus, the set of instructions, which when executed by the one or more processors, cause the apparatus to: transmit a request to the client device to authorize a detection of the current geographic location of the client device.

In accordance with the apparatus, the set of instructions, which when executed by the one or more processors, cause the apparatus to: detect, in response to receiving authorization from the client device, the current geographic location of the client device.

In accordance with the apparatus, the set of instructions, which when executed by the one or more processors, cause the apparatus to: receive, from the client device, a service request for one or more financial services offered by the financial institution.

In accordance with the apparatus, causing the display of the dashboard is also based on the service request.

In accordance with the apparatus, the dashboard includes a profile of a branch employee at a branch location of the financial institution, and the branch employee is associated with a financial service specified in the service request.

In accordance with the apparatus, the profile includes one or more of a digital image, job title, biography, a geographic location, and contact information of the branch employee.

In accordance with the apparatus, the apparatus comprises a financial institution server.

In accordance with the apparatus, the financial institution server comprises a computing device.

In accordance with one or more embodiments set forth, illustrated, and described herein, a computing device comprises one or more of the following: one or more processors; and a non-transitory memory coupled to the one or more processors, the non-transitory memory including a set of instructions, which when executed by the one or more processors, cause the computing device to: dynamically conduct a geographic location analysis of wireless network connectivity data, stored geographic location data, and sensor data relating to a current geographic location of a client device executing a mobile application or a desktop application associated with a financial institution over a communication network; and cause, based on the geographic location analysis, display of a dashboard on the client device and a widget on the dashboard.

In accordance with the computing device, the set of instructions, which when executed by the one or more processors, cause the computing device to: transmit a request to the client device to authorize a detection of the current geographic location of the client device.

In accordance with the computing device, the set of instructions, which when executed by the one or more processors, cause the computing device to: detect, in response to receiving authorization from the client device, the current geographic location of the client device.

In accordance with the computing device, the set of instructions, which when executed by the one or more processors, cause the computing device to: receive, from the client device, a service request for one or more financial services offered by the financial institution.

In accordance with the computing device, causing the display of the dashboard is also based on the service request.

In accordance with the computing device, the dashboard includes a profile of a branch employee at a branch location of the financial institution, and the branch employee is associated with a financial service specified in the service request.

In accordance with the computing device, the profile includes one or more of a digital image, job title, biography, a geographic location, and contact information of the branch employee.

In accordance with one or more embodiments set forth, illustrated, and described herein, a computer program product for including at least one non-transitory computer readable medium, comprising a set of instructions, which when executed by one or more processors of a computing device, cause the computing device to perform one or more of the following: dynamically conduct a geographic location analysis of wireless network connectivity data, stored geographic location data, and sensor data relating to a current geographic location of a client device executing a mobile application or a desktop application associated with a financial institution over a communication network; and cause, based on the geographic location analysis, display of a dashboard on the client device and a widget on the dashboard.

In accordance with the computer program product, the set of instructions, which when executed by the one or more processors, cause the computing device to: transmit a request to the client device to authorize a detection of the current geographic location of the client device.

In accordance with the computer program product, the set of instructions, which when executed by the one or more processors, cause the computing device to: detect, in response to receiving authorization from the client device, the current geographic location of the client device.

In accordance with the computer program product, the set of instructions, which when executed by the one or more processors, cause the computing device to: receive, from the client device, a service request for one or more financial services offered by the financial institution.

In accordance with the computer program product, causing the display of the dashboard is also based on the service request.

In accordance with the computer program product, the dashboard includes a profile of a branch employee at a branch location of the financial institution, and the branch employee is associated with a financial service specified in the service request.

In accordance with the computer program product, the profile includes one or more of a digital image, job title, biography, a geographic location, and contact information of the branch employee.

In accordance with one or more embodiments set forth, illustrated, and described herein, a computer-implemented method comprises one or more of the following: dynamically conducting, by one or more financial institution servers associated with a financial institution, a geographic location analysis of wireless network connectivity data, stored geographic location data, and sensor data relating to a current geographic location of a client device executing a mobile application or a desktop application associated with the financial institution over a communication network; and causing, by the one or more financial institution servers based on the geographic location analysis, display of a dashboard on the client device and a widget on the dashboard.

In accordance with the computer-implemented method, further comprising transmitting, by the one or more financial institution servers, a request to the client device to authorize a detection of the current geographic location of the client device.

In accordance with the computer-implemented method, further comprising detecting, by the one or more financial institution servers in response to receiving authorization from the client device, the current geographic location of the client device.

In accordance with the computer-implemented method, receiving, by the one or more financial institution servers from the client device, a service request for one or more financial services offered by the financial institution, and causing the display of the dashboard based on the service request.

In accordance with the computer-implemented method, the dashboard includes a profile of a branch employee at a branch location of the financial institution, and the branch employee is associated with a financial service specified in the service request.

In accordance with the computer-implemented method, the profile includes one or more of a digital image, job title, biography, a geographic location, and contact information of the branch employee.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the mobile device of FIG. 1.

FIG. 3 illustrates a block diagram of the personal computing device of FIG. 1.

FIG. 4 illustrates a block diagram of the one or more financial institution servers of FIG. 1.

FIGS. 5A and 5B respectively illustrate a dashboard that includes a widget of a personal branch employee of a financial institution, and a close-up view of the widget, in accordance with one or more embodiments set forth and described herein.

FIGS. 6A and 6B respectively illustrate a dashboard that includes a widget of a commercial financial services branch employee of the financial institution, and a close-up view of the widget, in accordance with one or more embodiments set forth and described herein.

FIGS. 7A and 7B respectively illustrate a dashboard that includes a widget of a wealth management branch employee of the financial institution, a close-up view of the widget, in accordance with one or more embodiments set forth and described herein.

FIGS. 8 through 12 respectively illustrate a computer-implemented method, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running or executing on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

As used herein, “widget” relates to electronic visual tiles that may be added to a home screen dashboard that are bigger than a regular application icon and have additional functionality. The widget may include shortcuts directly to popular features within a financial application.

A communication environment that facilitates enhanced user communication with a financial institution in support of user access and user management of user accounts at the financial institution. Upon the launching of a dashboard of financial institution on a client device, a user may transmit data related to one or more user accounts, and also receive data and information on one or more branch employees based on the geographic location of the user, or a user request or query for one or more financial services that are offered by the financial institution. Such data may be encrypted during communications between the client device and the one or more financial services.

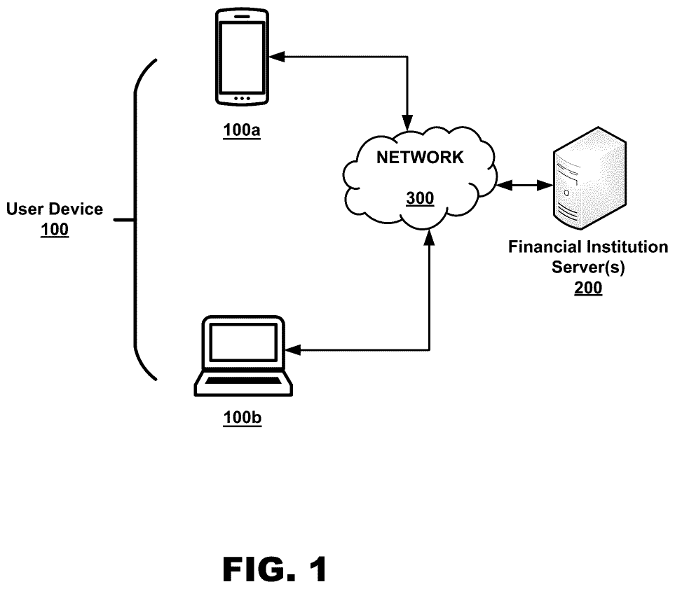

Turning to the figures, in which FIG. 1 illustrates a communication environment in which a user communicates with a financial institution. A client device 100 operating in the communication environment facilitates user access to and user management of one or more user accounts residing at one or more financial institution servers 200 of the financial institution. The communication environment includes the client device 100, the one or more financial institution servers 200, and a communications network 300 through which communication is facilitated between the client device 100 and the one or more financial institution servers 200.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

In accordance with one or more embodiments set forth, described, and/or illustrated herein, each server in the one or more financial institution servers 200 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

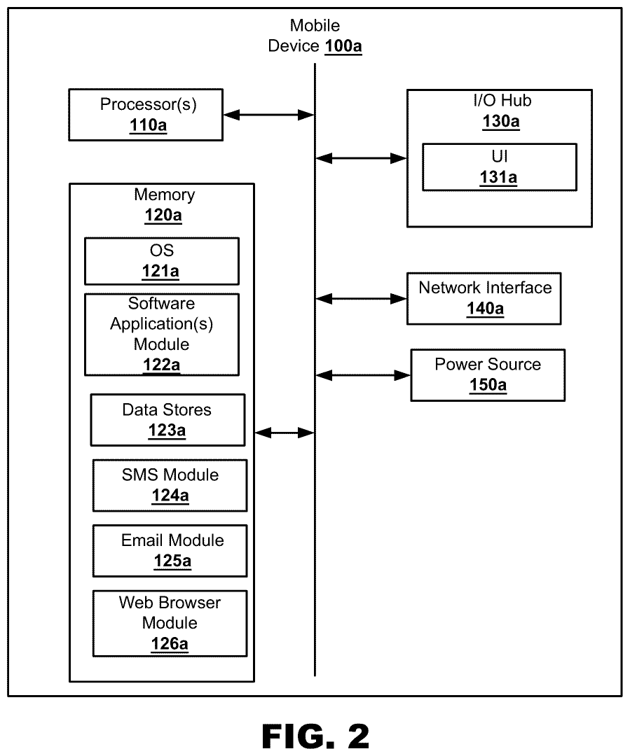

In the illustrated example embodiment of FIG. 2, the client device 100 comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause execution of an operating system 121a and one or more software applications of a software application module 122a that reside in the memory 120a. The one or more software applications residing in the memory 120a includes, but is not limited to, a financial institution application that is associated with the financial institution. The financial institution application comprises a mobile application that facilitates establishment of a secure connection between the mobile device 100a and the one or more financial institution servers 200. The one or more processors 110a are operable to execute the mobile application to facilitate user access to the one or more user accounts and user management of the one or more user accounts.

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS module 124a operable to facilitate user transmission and receipt of text messages via the mobile device 100a though the network 300. In one example embodiment, a user may receive text messages from the financial institution that are associated with the user access and the user management of the one or more user accounts. An email module 125a is operable to facilitate user transmission and receipt of email messages via the mobile device 100a through the network 300. In one example embodiment, a user may receive email messages from the financial institution that are associated with the user access and the user management of the one or more user accounts. A user may utilize a web browser module 126a that is operable to facilitate user access to one or more websites associated with the financial institution through the network 300.

In accordance with one or more embodiments set forth, described, and/or illustrated herein, the mobile device 100a includes an I/O hub 130a operatively connected to other systems and subsystems of the mobile device 100a. The I/O system 130a may include one or more of an input interface, an output interface, and a network controller to facilitate communications between the client device 100 and the server 200. The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes power source 150a that comprises a wired powered source, a wireless power source, a replaceable battery source, or a rechargeable battery source.

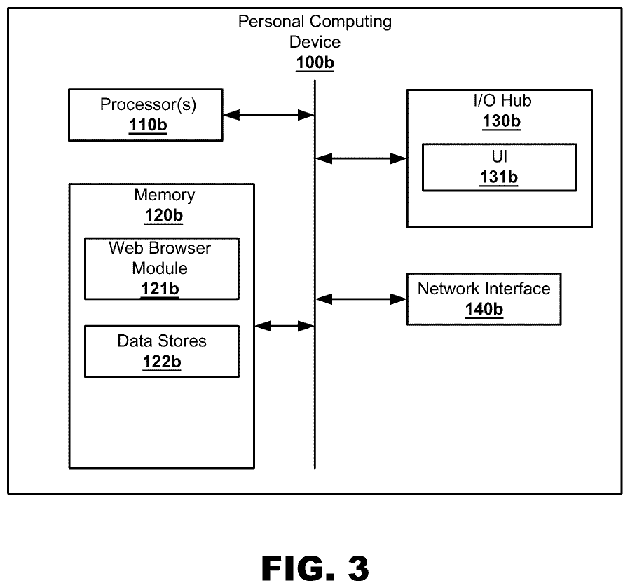

In the illustrated example embodiment of FIG. 3, the client device 100 comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110a, an I/O hub 130b, and a network interface 140b.

The memory 120b comprises a set of instructions of computer-executable program code. The set of instructions are executable by the one or more processors 110b to cause control of the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122b may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a, 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a, 110b may comprise at least one hardware circuit (e.g., an integrated circuit) operable to carry out instructions contained in program code. In embodiments in which there is a plurality of processors, such processors may work independently from each other, or one or more processors may work in combination with each other.

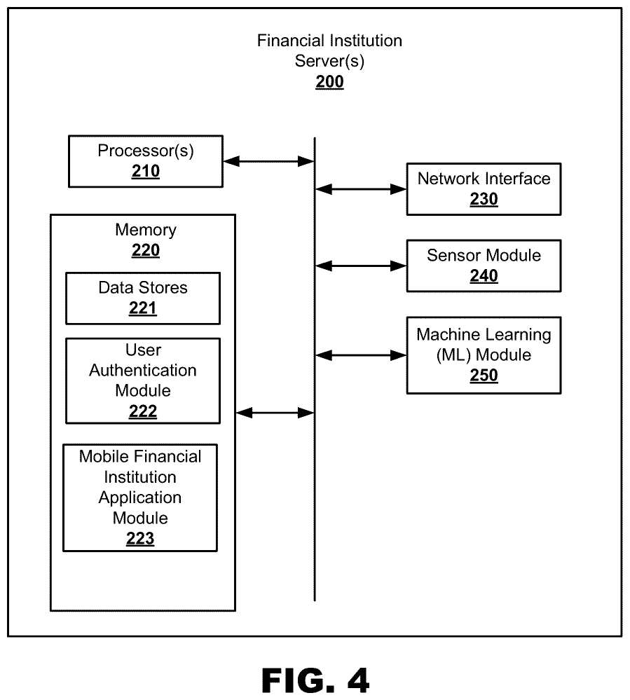

As illustrated in FIG. 4, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222 and a mobile financial institution application module 223 having one or more mobile financial institution applications that reside in the memory 220. In accordance with one or more embodiments set forth, described, and/or illustrated herein, the one or more financial institution servers 200 may individually or collectively execute the instructions to perform any one or more of the methodologies set forth, described, and illustrated herein.

The memory 220 also includes one or more data stores 221 that are operable to store one or more types of data, including but not limited to, user account data, user authentication data, sensor data, etc. For instance, the one or more data stores 221 may comprise a storage location on which resides one or more electronic files of data and information associated with wireless network connectivity data, stored geographic location data, and sensor data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the server(s) to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to cause the user authentication module 222 to authenticate a user in order to gain user access to the one or more user accounts. The user authentication module 222 may be caused to request user input user data or user identification that include, but are not limited to, user identity (e.g., username), a user passcode, a cookie, user biometric data, a private key, a token, and/or another suitable authentication data or information.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 223 are operable to communicate with the client device 100 in a manner which facilitates user access to the one or more user accounts in addition to user management of the one or more user accounts based on successful user authentication. The data exchanged between the client device and the one or more financial services may be encrypted during communications therebetween.

The sensor module 240 is operable, at least during execution of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and user management of the one or more user accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a user may, via the client device 100, execute a mobile application associated with the financial institution over the communication network 300. Upon being authenticated by the user authentication module 222, the user may transmit via the client device 100, a service request or query to the one or more financial institution server(s) 200 for one or more financial services that are offered by the financial institution. Such financial services may include, but are not limited to, personal financial services, commercial financial services, and wealth management financial services.

Responsive to receipt of the service request transmission, the set of instructions are executable by the one or more processors 210 to cause the one or more processors 210 to transmit a request or query to the client device 100 to authorize a detection of the current geographic location of the client device 100. Responsive to the one or more financial institution server(s) 200 receiving authorization from the client device 100, the set of instructions are executable by the one or more processors 210 to cause the one or more financial institution server(s) 200 to detect the current geographic location of the client device 100. Alternatively, this disclosure contemplates the request or query to authorize the detection of the current geographic location of the client device 100 occurring temporally before user authentication is conducted.

The set of instructions are executable by the one or more processors 210 to cause the one or more financial institution server(s) 200 to dynamically conduct a geographic location analysis of wireless network connectivity data, stored geographic location data residing in the memory 220, and sensor data relating to the detected current geographic location of the client device 100. The wireless network connectivity data may include but is not limited to, an internet protocol (IP) address of the client device 100, network identifier for the network 300, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs, etc. The sensor data may include but is not limited to, global positioning system (GPS) data of the client device 100. This disclosure contemplates conducting the geographic location analysis based on any data indicative of a geographic location of the client device 100 and which optimizes or otherwise transforms the performance and functionality of the one or more embodiments in a manner that falls within the spirit and scope of the principles of this disclosure.

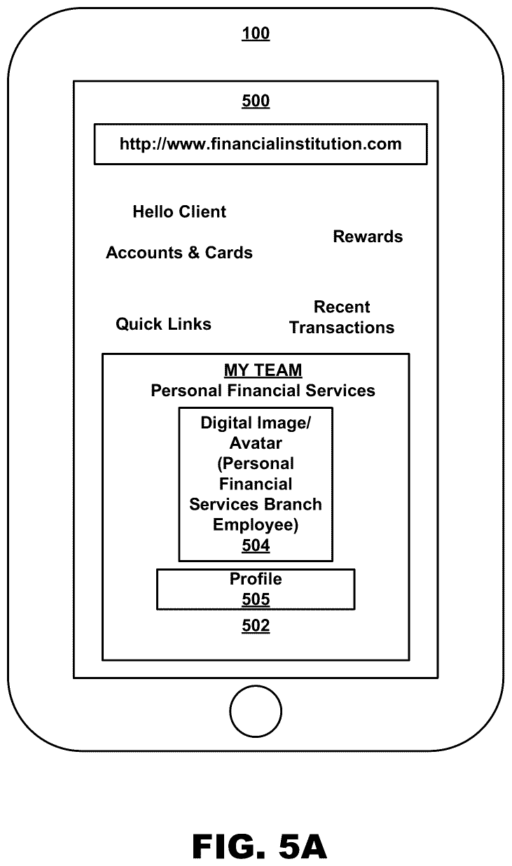

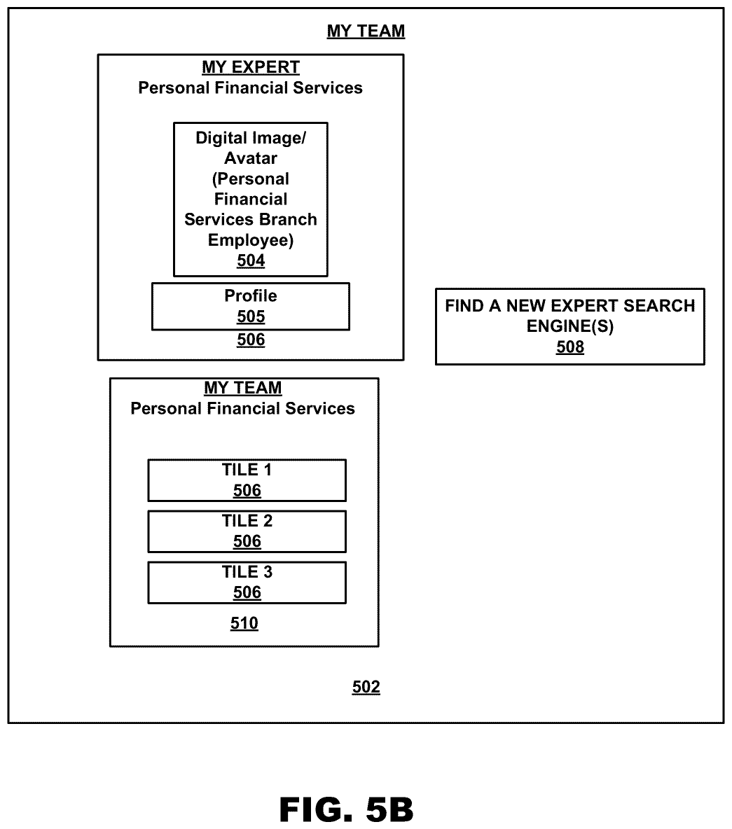

As illustrated in FIGS. 5A through 8 respectively, the computer-executable program code may instruct the one or more processors 210 to cause, based on the geographic location analysis, display of a dashboard 500, 600, 700 on the UI 131a, 131b of the client device 100 based on the geographic location analysis. The computer-executable program code may instruct the one or more processors 210 to cause generation of a display of a widget 502, 602, 702 on the dashboard 500, 600, 700 based on the geographic location analysis. The dashboard 500, 600, 700 includes a profile 505, 605, 705 of a branch employee at a branch location of the financial institution. The branch employee may be designated as a “primary branch employee.”

The dashboards 500, 600, 700 allow a branch employee to post messages, notifications about articles that may be of interest to the user, and upcoming speaking engagements for review by the client. The dashboards 500, 600, 700 also allow for dynamic messaging pop-ups to provide a plurality of notifications to the user. For example, the financial institution may transmit a notification that a particular wealth advisor is speaking on Bloomberg® today, and how it may impact a financial portfolio of the user. The dashboards may include a link (or button) after every pop-up showing an article or vlog which would allow appointment scheduling with a branch employee based on the notification.

The computer-executable program code may instruct the one or more processors 210 to cause the display of the dashboard based on the service request made by the user. For example, the branch employee whose profile 505, 605, 705 is visually displayed on the UI 131a, 131b of the client device 100 may be associated with a specific financial service requested by the user via service request. The profile may include a plurality of information related to the branch employee. Such information may include, but is not limited to, a digital image (e.g., an avatar or a photographic image) of the branch employee, job title of the branch employee, biography of the branch employee, a specific geographic location of the branch of the financial institution associated with the branch employee, and contact information (e.g., email address, telephone number, etc.) of the branch employee.

As illustrated in FIGS. 5A and 5B, should the user, via the client device 100, transmit a service request for services related to personal financial services, the one or more financial institution server(s) 200 may cause the display of a dashboard 500 that includes a widget 502 of a personal financial services branch employee 504 of the financial institution, and a close-up view of the widget 502. In FIG. 5B, the personal financial services branch employee 504 chosen to service the user is designated as “my expert” in tile 506. The widget 502 also includes one or more search engine entry fields 508 to facilitate a user selectively finding a new expert, and a section 510 to save and present tiles 506 with a plurality of personal financial services branch service employees 504 that form the team that may service the user.

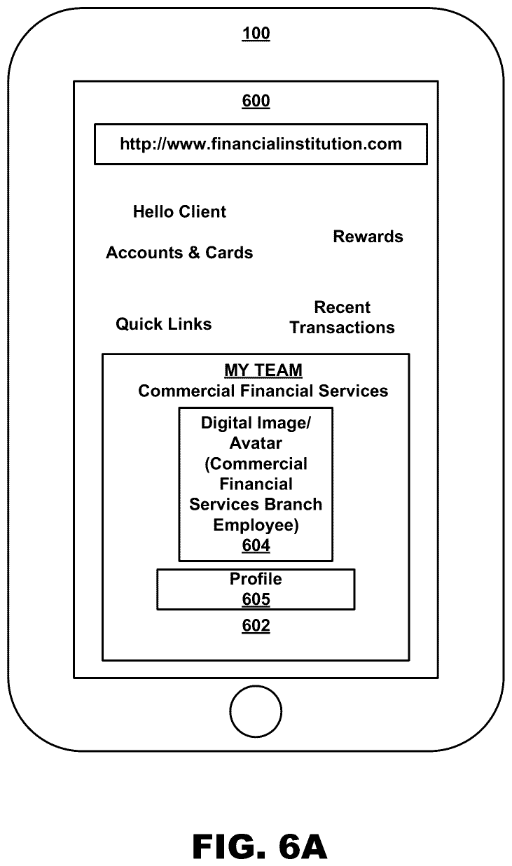

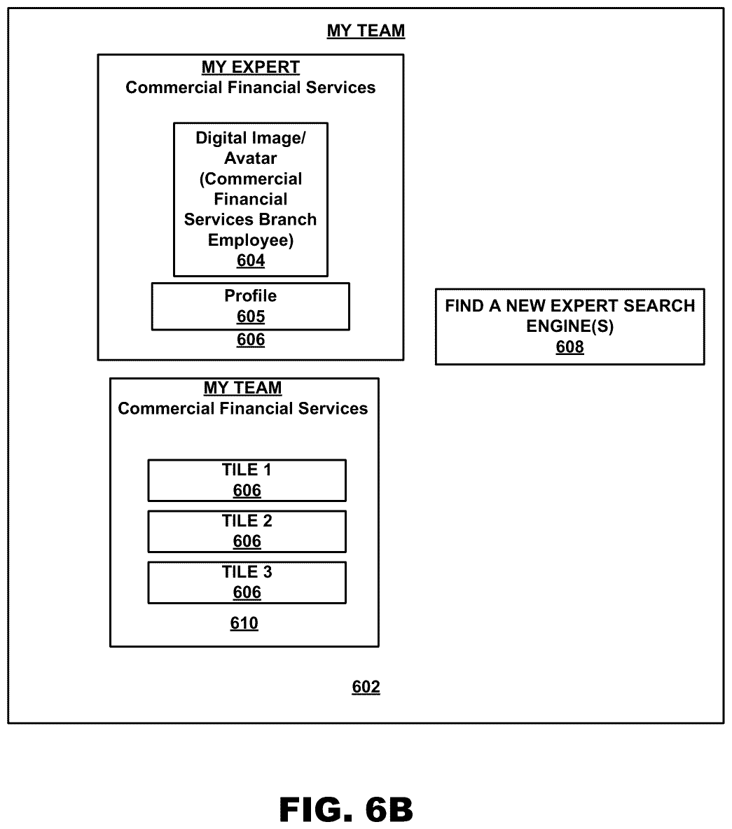

As illustrated in FIGS. 6A and 6B, should the user transmit, via the client device 100, a service request for services related to commercial financial services, the one or more financial institution server(s) 200 may cause the display of another dashboard 600 that includes a widget 602 of a commercial financial services branch employee of the financial institution, and a close-up view of the widget 602. In FIG. 6B, the commercial financial services branch employee 604 chosen to service the user is designated as “my expert” in tile 606. The widget 602 also includes a search engine entry fields 608 to facilitate a user selectively finding a new expert, and a section 610 to save and present tiles 606 with a plurality of commercial financial services branch employees 604 that form the team that may service the user.

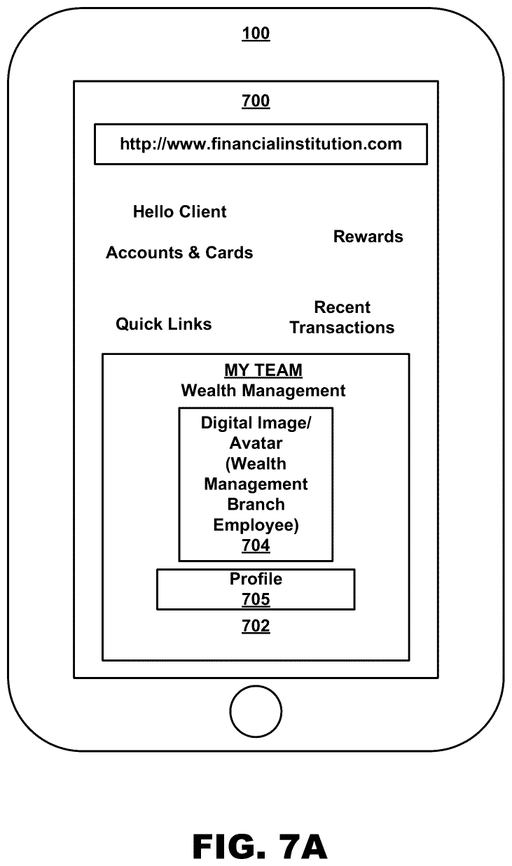

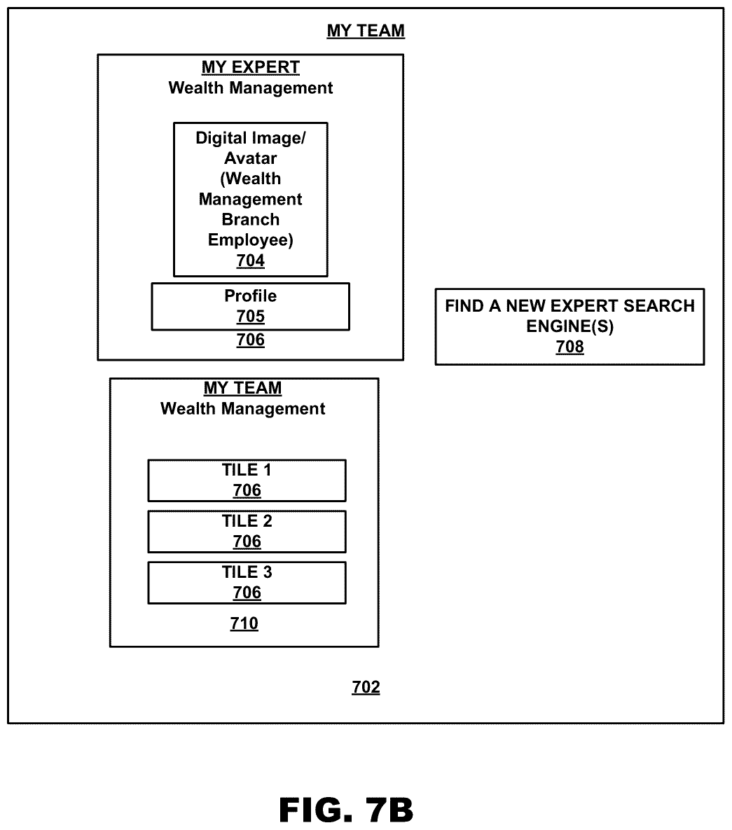

As illustrated in FIGS. 7A and 7B, should the user transmit a service request for services related to wealth management financial services, the one or more financial institution server(s) 200 may cause the display of a dashboard 700 that includes a widget 702 of a wealth management services branch employee of the financial institution, and a close-up view of the widget 702. In FIG. 7B, the wealth management services branch employee 704 chosen to service the user is designated as “my expert” in tile 706. The widget 702 also includes a search engine entry fields 708 to facilitate a user selectively finding a new expert, and a section 710 to save and present tiles 706 with a plurality of wealth management services branch employees 704 that form the team that may service the user.

In accordance with one or more embodiments set forth, described, and/or illustrated herein, the computer-executable program code may instruct the one or more processors 210 to cause presentation of a branch employee search engine in the widgets 502, 602, 702 that facilitate conducting a user search based on a plurality of criteria. Suitable criteria may include, but are not limited to, the name of a branch employee, the experience level of a branch employee, the education level of a branch employee, etc. The computer-executable program code may instruct the one or more processors 210 to receive from the client device 100 transmission of at least one criteria among the plurality of service criteria. Responsive to receipt of the at least one criteria, the computer-executable program code may instruct the one or more processors 210 to present one or more branch employees for selection by the user. Responsive to receive transmission of a second branch employee that is selected by the client device 100, the computer-executable program code may instruct the one or more processors 210 to replace the branch employee in one of the widgets 502, 602, 702 with a second branch employee. Alternatively, the computer-executable program code may instruct the one or more processors 210 to add the second branch employee in one of the widgets 502, 602, 702.

In accordance with one or more embodiments set forth, described, and/or illustrated herein, temporally after the display of one of the dashboards 500, 600, 700 that includes the profile 505, 605, 705 of the branch employee, the computer-executable program code may instruct the one or more processors 210 to dynamically detect online user communication via the network 300 between the client device 100 and a third branch employee. Responsive to the detection, the computer-executable program code may instruct the one or more processors 210 to transmit to the client device 100 a request or query of whether the user would like to replace the branch employee in one of the widgets 502, 602, 702 with the third branch employee. Alternatively, the computer-executable program code may instruct the one or more processors 210 to transmit to the client device 100 a request or query of whether the user would like to add the third branch employee in one of the widgets 502, 602, 702.

In accordance with one or more embodiments set forth, described, and/or illustrated herein, temporally after the display of the dashboard 500, 600, 700 that includes the profile 505, 605, 705 of the branch employee, the computer-executable program code may instruct the one or more processors 210 to dynamically detect online user communication via the network 300 between the client device 100 and a fourth branch employee. Responsive to the detection, the computer-executable program code may instruct the one or more processors 210 to automatically transmit a push notification to the client device 100 with a tile of the fourth branch employee. Responsive to receipt of a user request to add the fourth employee in the widget 502, 602, 702, the computer-executable program code may instruct the one or more processors 210 to add the fourth branch employee in the widget 502, 602, 702.

In accordance with one or more embodiments set forth, described, and/or illustrated herein, the computer-executable program code may instruct the one or more processors 210 to dynamically monitor activity of the client device 100 during user engagement with the one or more user accounts at the financial institution. The computer-executable program code may instruct the one or more processors 210 to control the ML module 250 in a manner that determines a user pattern of a frequent branch location used by the user via the client device 100. Responsive to the determination of a user pattern, the computer-executable program code may instruct the one or more processors 210 to transmit a push notification to the client device 100 with a request or query of whether the user would like to add a fifth branch employee based on in the widget 502, 602, 702 based on the frequent branch location.

In accordance with one or more embodiments set forth, described, and/or illustrated herein, the computer-executable program code may instruct the one or more processors 210 to launch a user-selectable appointment calendar integrated into the widget 502, 602, 702 to facilitate via the client device 100 a user-initiated calendar appointment request with a branch employee. Responsive to receiving transmission of the user-initiated calendar appointment request, the computer-executable program code may instruct the one or more processors 210 to schedule an appointment either virtually or in-person or IRL at a designated branch office. A link may be provided having the email address of the branch employee (i.e., personalized unique resource locator (PURL)). The designated appointment can be configured to synchronize with another calendar that is operating on the client device 100 in order to record the designated appointment date and appointment time. This disclosure contemplates implementing the appointment schedule using a Salesforce® or other scheduling platform.

In accordance with one or more embodiments set forth, described, and/or illustrated herein, the computer-executable program code may instruct the one or more processors 210 to enable secure email and text message communications between the client device 100 and a branch employee.

Although a branch employee 504, 604, 704 displayed in the widgets 502, 602, 702 is assigned to service a user account at the financial institution, embodiments are not limited thereto. This disclosure contemplates that a user may have a plurality of branch employees assigned to service a user account based on skill set, need, etc. For example, a user could be assigned a branch employee 504, 604, 704 to service its general needs, and another branch employee 504, 604, 704 (e.g., designated as an “expert”) having a skill level (e.g., financial advisor, trust advisor, etc.) and experience to service any specialized needs of the user. In addition, one or more supplemental branch employees may be added to service the needs of the user throughout the life of the relationship between the user and the financial institution.

A branch employee in each of the widgets 502, 602, 702 assigned to service a user account may be either designated by the financial institution itself through a variety of internal criteria (or data points) for each of the service categories (e.g., personal, commercial, wealth management, etc.) or the branch employee may be selected by the user.

In accordance with one or more embodiments set forth, described, and/or illustrated herein, a random branch employee may be automatically displayed at a dashboard 500, 600, 700 at the outset of the relationship between the user and the financial institution.

In accordance with one or more embodiments set forth, described, and/or illustrated herein, a user may be initially assigned a branch employee by the financial institution based on a detected current geographic location of the client device 100.

In accordance with one or more embodiments set forth, described, and/or illustrated herein, a user may conduct an online search using the mobile application associated with a financial institution to service the user account.

In accordance with one or more embodiments set forth, described, and/or illustrated herein, a branch employee can be assigned to service the user account based on the type of user account (e.g., personal, commercial, wealth management, etc.).

In accordance with one or more embodiments set forth, described, and/or illustrated herein, a branch employee who would ordinarily not be assigned to the user account can be selectively assigned by the user based on a relationship (e.g., a good rapport) with a branch employee by action of the user saving the profile of the branch employee to a digital profile 505, 605, 705 or dashboard 500, 600, 700 of the user.

In accordance with one or more embodiments set forth, described, and/or illustrated herein, should a user travel between a home geographic location to another geographic location, the user may selectively assign (e.g., on a temporary basis) a branch employee located in the destination geographic location or a branch employee located at the nearest branch office relative to the destination geographic location.

In accordance with one or more embodiments set forth, described, and/or illustrated herein, a branch employee may be assigned to service a user account using the ML module 250 which studies the behavioral patterns of the user. For example, the ML module 250 may determine that the user is not being serviced at a branch office most adjacent to its home geographic location, but rather a branch location in a different geographic location. In that case, the financial institution may recommend (e.g., via push notification) that the user designate a branch employee at the different geographic location to service the user account.

In accordance with one or more embodiments set forth, described, and/or illustrated herein, should the user have a wealth management account (e.g., trust account, brokerage account, etc.), a more experienced branch employee having a specialized skillset (e.g., a financial advisor) may be assigned to service the wealth management account.

In accordance with one or more embodiments set forth, described, and/or illustrated herein, the client device 100 and the one or more financial institution server(s) 200 could function in a fully virtualized environment. A virtual machine is where all hardware is virtual and operation is run or executed over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running or executing on hardware platform, and one or more virtual machines running or executing on hardware platform by way of virtualization software. Virtualization software is therefore logically interposed between the physical hardware of hardware platform and guest system software running or executing “in” virtual machine. Memory of the hardware platform may store virtualization software and guest system software running or executing in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method 100 described herein may be at least partially processor-implemented, the processor 114 being an example of hardware. For example, at least some of the operations of a method may be performed by one or more processors 114 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

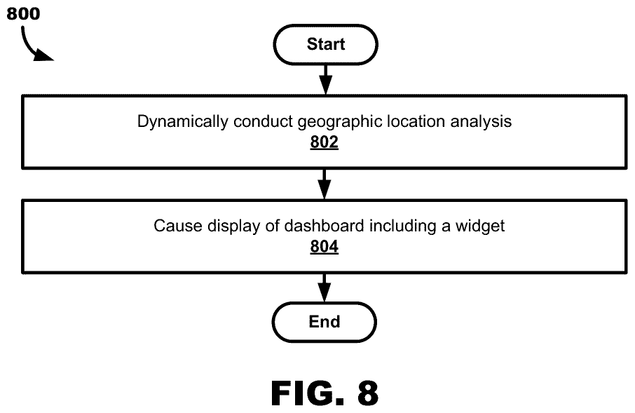

Illustrated examples shown in FIGS. 8 to 12 set forth computer-implemented methods 800, 900, 1000, 1100, and 1200. In one or more examples, the respective flowcharts of the computer-implemented methods 800, 900, 1000, 1100, and 1200 may be implemented by the one or more processors 210 of the one or more financial institution servers 200. In particular, the computer-implemented methods 1800, 900, 1000, 1100, and 1200 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 800, 900, 1000, 1100, and 1200 set forth, described, and/or illustrated herein, or provides functionality set forth, described, and/or illustrated.

As illustrated in FIG. 8, illustrated process block 802 includes dynamically conducting, by one or more financial institution servers associated with a financial institution, geographic location analysis of wireless network connectivity data, stored geographic location data, and sensor data relating to a current geographic location of a client device executing a mobile application or a desktop application associated with the financial institution over a communication network.

The computer-implemented method 800 may then proceed to illustrated process block 804, which includes causing, by the one or more financial institution servers based on the geographic location analysis, display of a dashboard on the client device and a widget on the dashboard.

In accordance with the example illustrated process block 804, display of the widget includes display of a profile of a branch employee at a branch location of the financial institution.

In accordance with the example illustrated process block 804, display of the widget includes presentation of a user-selectable appointment calendar into the widget to enable a user-initiated calendar appointment request with the displayed, branch employee.

The computer-implemented method 800 may terminate or end after execution of process block 804.

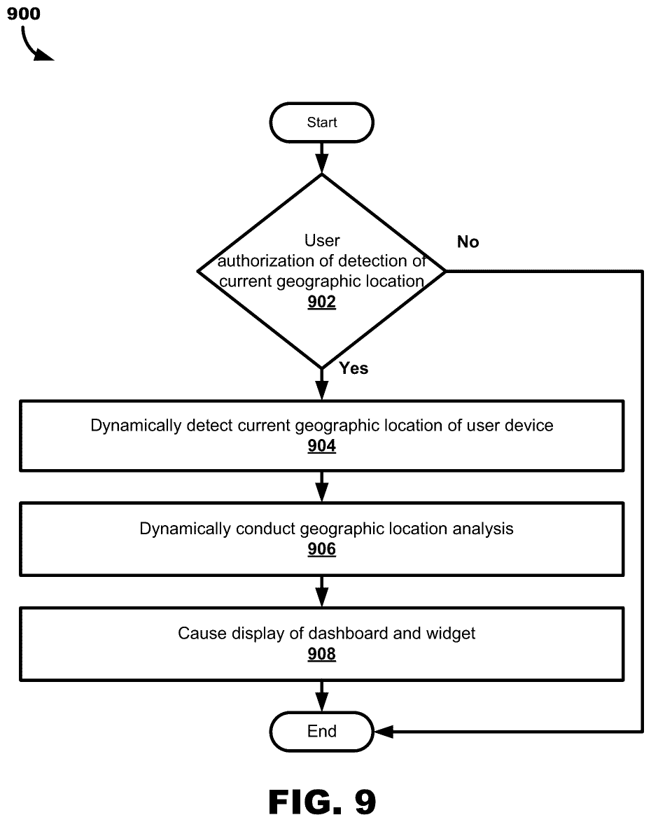

As illustrated in FIG. 9, illustrated decision block 902 includes transmitting, by one or more financial institution servers associated with a financial institution, a request or prompt to the client device to authorize a detection of the current geographic location of a client device executing a mobile application or a desktop application associated with a financial institution over a communication network.

If “No,” i.e., should the user not authorize detection of the current geographic location of the client device, the computer-implemented method 900 then may terminate or end.

If “Yes,” i.e., should the user authorize detection of the current geographic location of the client device, the computer-implemented method 900 then proceeds to process block 904, which includes dynamically detecting, by the one or more financial institution servers, the current geographic location of the client device.

The computer-implemented method 900 may then proceed to illustrated process block 906, which includes dynamically conducting, by the one or more financial institution servers, geographic location analysis of wireless network connectivity data, stored geographic location data, and sensor data.

The computer-implemented method 900 may then proceed to illustrated process block 908, which includes causing, by the one or more financial institution servers based on the geographic location analysis, display of a dashboard on the client device and a widget on the dashboard.

In accordance with the example illustrated process block 908, display of the widget includes display of a profile of a branch employee at a branch location of the financial institution.

In accordance with the example illustrated process block 908, display of the widget includes presentation of a user-selectable appointment calendar into the widget to enable a user-initiated calendar appointment request with the displayed, branch employee.

The method 900 may terminate or end after execution of process block 908.

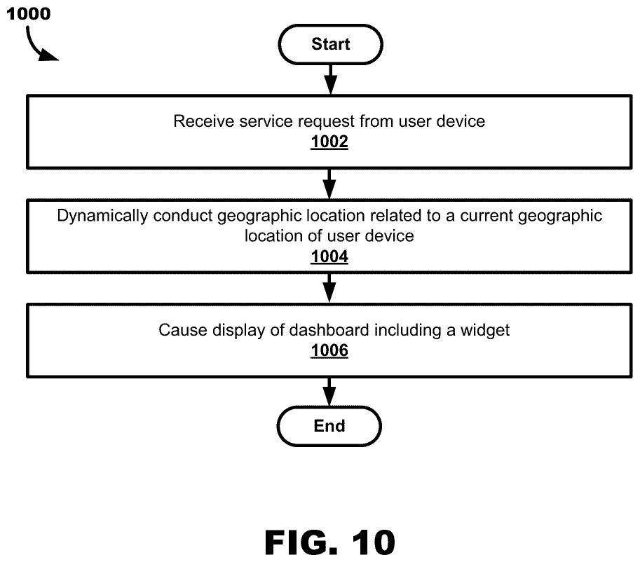

As illustrated in FIG. 10, illustrated process block 1002 includes receiving, by one or more financial institution servers associated with a financial institution and from a client device executing a mobile application or a desktop application associated with the financial institution over a communication network, a service request for one or more financial services offered by the financial institution.

The computer-implemented method 1000 may then proceed to illustrated process block 1004, which includes dynamically conducting geographic location analysis of wireless network connectivity data, stored geographic location data, and sensor data relating to a current geographic location of the client device.

The computer-implemented method 1000 may then proceed to illustrated process block 1006, which includes causing, by the one or more financial institution servers based on the geographic location analysis, display of a dashboard on the client device and a widget on the dashboard.

In accordance with the example illustrated process block 1006, display of the widget includes display of a profile of a branch employee at a branch location of the financial institution.

In accordance with the example illustrated process block 1006, display of the profile includes display of the profile of the branch employee that is associated with a financial service specified in the service request.

In accordance with the example illustrated process block 1006, display of the widget includes presentation of a user-selectable appointment calendar into the widget to enable a user-initiated calendar appointment request with the displayed, branch employee.

The computer-implemented method 1000 may terminate or end after execution of process block 1006.

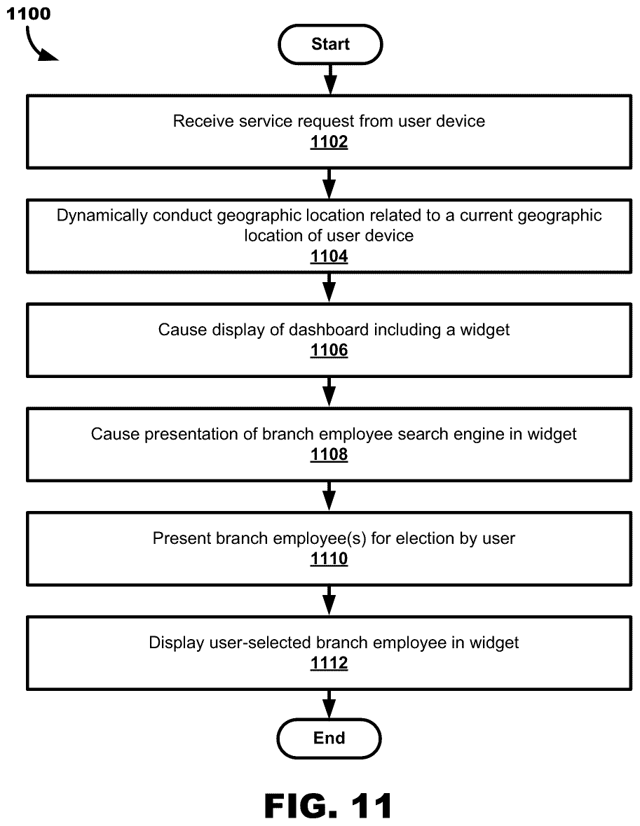

As illustrated in FIG. 11, illustrated process block 1102 includes receiving, by one or more financial institution servers associated with a financial institution and from a client device executing a mobile application or a desktop application associated with the financial institution over a communication network, a service request for one or more financial services offered by the financial institution.

The computer-implemented method 1100 may then proceed to illustrated process block 1104, which includes dynamically conducting, by the one or more financial institution servers, geographic location analysis of wireless network connectivity data, stored geographic location data, and sensor data relating to a current geographic location of the client device.

The computer-implemented method 1100 may then proceed to illustrated process block 1106, which includes causing, by the one or more financial institution servers based on the geographic location analysis, display of a dashboard on the client device and a widget on the dashboard.

In accordance with the example illustrated process block 1106, display of the dashboard includes display of a profile of a branch employee at a branch location of the financial institution.

In accordance with the example illustrated process block 1106, display of the profile includes display of the profile of the branch employee that is associated with a financial service specified in the service request.

The computer-implemented method 1100 may then proceed to illustrated process block 1108, which includes causing, by the one or more financial institution servers, presentation of a branch employee search engine in the widget that facilitates conducting a user search based on a plurality of criteria.

The computer-implemented method 1100 may then proceed to illustrated process block 1110, which includes causing, by the one or more financial institution servers, display of one or more branch employees for selection by the user in response to receipt of the at least one criteria from the client device.

The computer-implemented method 1100 may then proceed to illustrated process block 1112, which includes causing, by the one or more financial institution servers, display of the profile of the user-selected branch employee in the widget.

In accordance with the example illustrated process block 1112, display of the profile of the user-selected branch employee includes replacing the profile of the branch employee in the widget with the profile of the user-selected branch employee.

In accordance with the example illustrated process block 1112, display of the profile of the user-selected branch employee includes adding the profile of the user-selected branch employee branch employee in the widget with the profile of the branch employee.

In accordance with the example illustrated process block 1112, display of the widget includes presentation of a user-selectable appointment calendar into the widget to enable a user-initiated calendar appointment request with the displayed, user-selected branch employee.

The computer-implemented method 1100 may terminate or end after execution of process block 1112.

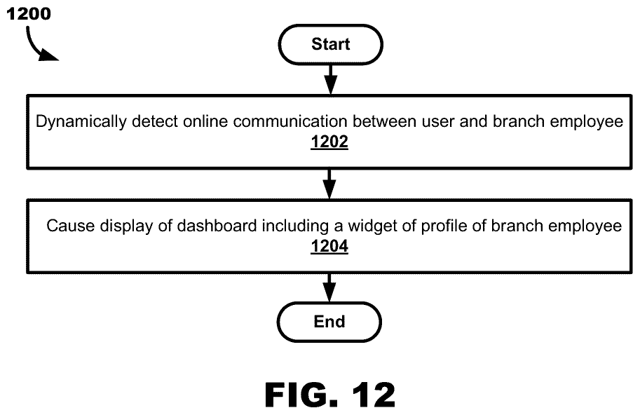

As illustrated in FIG. 12, illustrated process block 1202 includes dynamically detecting, by one or more financial institution servers associated with a financial institution and from a client device executing a mobile application or a desktop application associated with the financial institution over a communication network, online communication between the client device and a branch employee of the financial institution.

The computer-implemented method 1200 may then proceed to illustrated process block 1204, which includes causing, by the one or more financial institution servers based on the geographic location analysis, display of a dashboard on the client device and a widget on the dashboard.

In accordance with the example illustrated process block 1204, display of the widget includes display of a profile of the branch employee in the widget.

In accordance with the example illustrated process block 1204, display of the widget includes presentation of a user-selectable appointment calendar into the widget to enable a user-initiated calendar appointment request with the displayed branch employee.

The computer-implemented method 1200 may terminate or end after execution of process block 1204.

In accordance with one or more embodiments set forth, described, and/or illustrated herein, the client device 100 and the one or more financial institution servers 200 could function in a fully virtualized environment. A virtual machine is where all hardware is virtual and the operation is run or executed over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software executing on hardware platform, and one or more virtual machines executing on hardware platform by way of virtualization software. Virtualization software is therefore logically interposed between the physical hardware of hardware platform and guest system software executing “in” virtual machine.

Memory of the hardware platform may store virtualization software and guest system software executing in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 210 being an example of hardware. For example, at least some of the operations of the computer-implemented methods may be performed by the one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions, which when executed by the one or more processors, cause the apparatus to:
dynamically conduct a geographic location analysis of wireless network connectivity data, stored geographic location data, and sensor data relating to a current geographic location of a client device executing a mobile application or a desktop application associated with a financial institution over a communication network; and
cause, based on the geographic location analysis, display of a dashboard on the client device and a widget on the dashboard.

2. The apparatus of claim 1, wherein the set of instructions, which when executed by the one or more processors, cause the apparatus to:
transmit a request to the client device to authorize a detection of the current geographic location of the client device.

3. The apparatus of claim 2, wherein the set of instructions, which when executed by the one or more processors, cause the apparatus to:
detect, in response to receiving authorization from the client device, the current geographic location of the client device.

4. The apparatus of claim 1, wherein the set of instructions, which when executed by the one or more processors, cause the apparatus to:
receive, from the client device, a service request for one or more financial services offered by the financial institution.

5. The apparatus of claim 4, wherein causing the display of the dashboard is also based on the service request.

6. The apparatus of claim 5, wherein:
the dashboard includes a profile of a branch employee at a branch location of the financial institution, and
the branch employee is associated with a financial service specified in the service request.

7. The apparatus of claim 6, wherein the profile includes one or more of a digital image, job title, a geographic location, and contact information of the branch employee.

8. A computer program product for including at least one non-transitory computer readable medium, comprising a set of instructions, which when executed by one or more processors of a computing device, cause the computing device to:
dynamically conduct a geographic location analysis of wireless network connectivity data, stored geographic location data, and sensor data relating to a current geographic location of a client device executing a mobile application or a desktop application associated with a financial institution over a communication network; and
cause, based on the geographic location analysis, display of a dashboard on the client device and a widget on the dashboard.

9. The computer program product of claim 8, wherein the set of instructions, which when executed by the one or more processors, cause the computing device to:
transmit a request to the client device to authorize a detection of the current geographic location of the client device.

10. The computer program product of claim 9, wherein the set of instructions, which when executed by the one or more processors, cause the computing device to:
detect, in response to receiving authorization from the client device, the current geographic location of the client device.

11. The computer program product of claim 8, wherein the set of instructions, which when executed by the one or more processors, cause the computing device to:
receive, from the client device, a service request for one or more financial services offered by the financial institution.

12. The computer program product of claim 11, wherein causing the display of the dashboard is also based on the service request.

13. The computer program product of claim 12, wherein:
the dashboard includes a profile of a branch employee at a branch location of the financial institution, and
the branch employee is associated with a financial service specified in the service request.

14. The computer program product of claim 13, wherein the profile includes one or more of a digital image, job title, a geographic location, and contact information of the branch employee.

15. A computer-implemented method, comprising:
dynamically conducting, by one or more financial institution servers associated with a financial institution, a geographic location analysis of wireless network connectivity data, stored geographic location data, and sensor data relating to a current geographic location of a client device executing a mobile application or a desktop application associated with the financial institution over a communication network; and
causing, by the one or more financial institution servers based on the geographic location analysis, display of a dashboard on the client device and a widget on the dashboard.

16. The computer-implemented method of claim 15, further comprising transmitting, by the one or more financial institution servers, a request to the client device to authorize a detection of the current geographic location of the client device.

17. The computer-implemented method of claim 16, further comprising detecting, by the one or more financial institution servers in response to receiving authorization from the client device, the current geographic location of the client device.

18. The computer-implemented method of claim 17, further comprising:
receiving, by the one or more financial institution servers from the client device, a service request for one or more financial services offered by the financial institution, and
causing, by the one or more financial institution servers, the display of the dashboard based on the service request.

19. The computer-implemented method of claim 18, wherein:
the dashboard includes a profile of a branch employee at a branch location of the financial institution, and
the branch employee is associated with a financial service specified in the service request.

20. The computer-implemented method of claim 19, wherein the profile includes one or more of a digital image, job title, a geographic location, and contact information of the branch employee.
